(19) United States
(12) Patent Application Publication
(10) Pub. No.: US 2012/0292174 A1
(43) Pub. Date: Nov. 22, 2012

(54) SWITCH ACTUATOR

(76) Inventors: Pat Y. Mah, Kowloon (HK); Alexander Joshef Kalogroulis, Surrey (GB)

(21) Appl. No.: 13/445,911

(22) Filed: Apr. 12, 2012

(30) Foreign Application Priority Data
May 19, 2011 (GB) 1108378.9

(51) Int. Cl. H01H 43/10

(52) U.S. Cl. 200/573

(57) ABSTRACT

The present invention provides a retrofit actuator that can be fitted interchangeably to either a toggle switch or a rocker switch and which mimics both the up and down action required to operate a toggle switch and the pushing force required to operate a rocker switch, the retrofit actuator capable of being operated either directly by pressing an on/off button on the switch actuator itself or remotely by sending a signal from a remote control or other sender unit such as a passive infra red detector or a programmable central sender unit that can control one or more switch actuators from a remote location.

This invention relates to retrofit actuators for toggle and rocker type switches.

Household light circuits often consist of a ceiling light and a toggle or rocker style on/off wall switch located just inside the entrance door to a room. This arrangement is convenient for switching on a light when entering a room and then switching, it off again when leaving the room. However in a bedroom a typical pattern of use would be to switch on the light when entering the room and then having to return to the wall switch to switch off the light before returning to bed in the darkness. A common solution is to have a two way circuit installed so that a second switch on the circuit is placed adjacent to the bed. This allows the light to be switched on at the first switch when entering the bedroom and then switched of at the second switch. If no such two way circuit is present then the cost of installation can be prohibitive.

A first switch actuator described in U.S. Pat. No. 5,719,362 describes a timer that can be fitted against a toggle switch to flick the switch according to a preset programme. A second switch actuator described in U.S. Pat. No. 7,189,936 describes a retrofit actuator that can be fitted against a rocker switch to flick the switch according to a preset programme. Neither of these actuators can be operated remotely from a distance and both of them have an on button and an off button to override the preset programme. Neither can be used remotely and they cannot be interchangeably fitted to a rocker switch or a toggle switch as the forces required to operate each type of switch are different.

Accordingly there remains a need for an easy to mount retrofit switch actuator that can be quickly mounted interchangeably to either a rocker switch or a toggle switch and which can be operated both directly or remotely so that a user can place the actuator over the light switch and then operate the switch actuator in the manner of a two way switch by either pressing an on/off button on the switch actuator or by pressing a button on a remote control.

The present invention meets the above identified needs by providing a retrofit actuator that can be fitted interchangeably to either a toggle switch or a rocker switch and which mimics both the up and down action required to operate a toggle switch and the pushing force required to operate a rocker switch, the retrofit actuator capable of being operated either directly by pressing an on/off button on the switch actuator itself or remotely by sending a signal from a remote control or other sender unit such as a passive infra red detector or a programmable central sender unit that can control one or more switch actuators from a remote location.

The invention will now be described solely by way of example and with reference to the accompanying drawings in which:

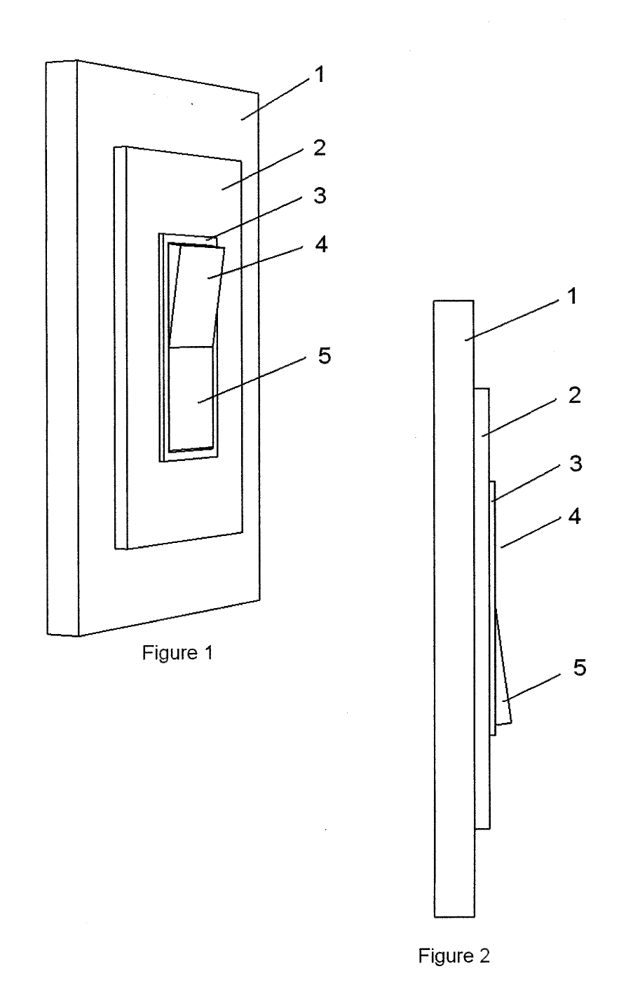

FIG. 1 shows a rocker switch, mounted on a panel, in the off position.

FIG. 2 shows a side view of a rocker switch in the on position.

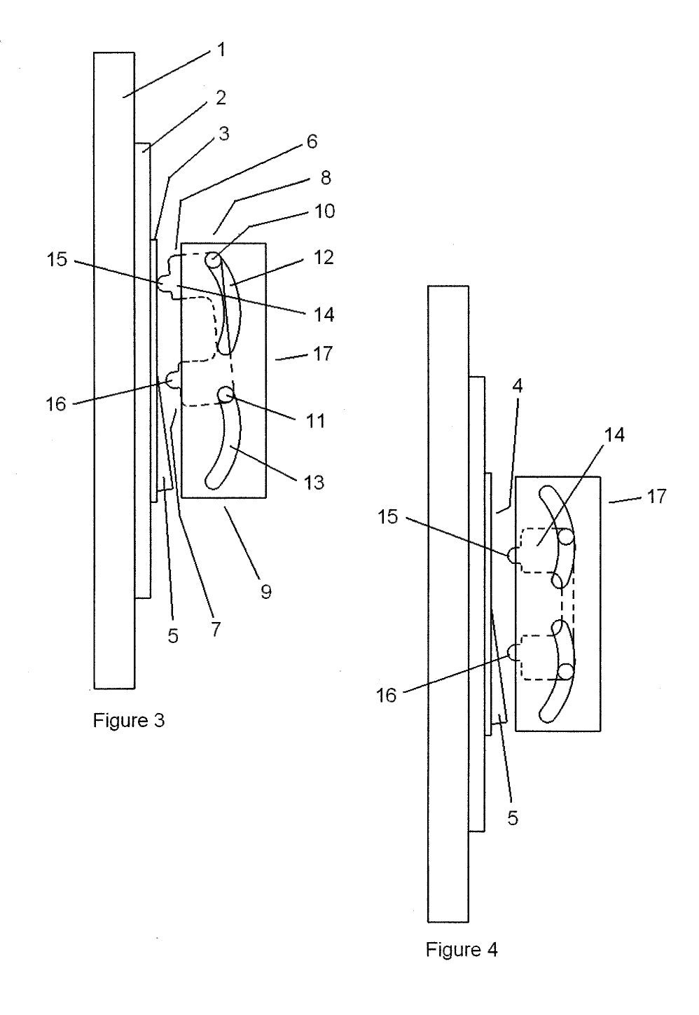

FIG. 3 shows a side view of an actuator and guide plate adjacent to a rocker switch which is in the on position.

FIG. 4 shows the same components as in FIG. 3 but with the actuator moved to a mid position along the guide plate.

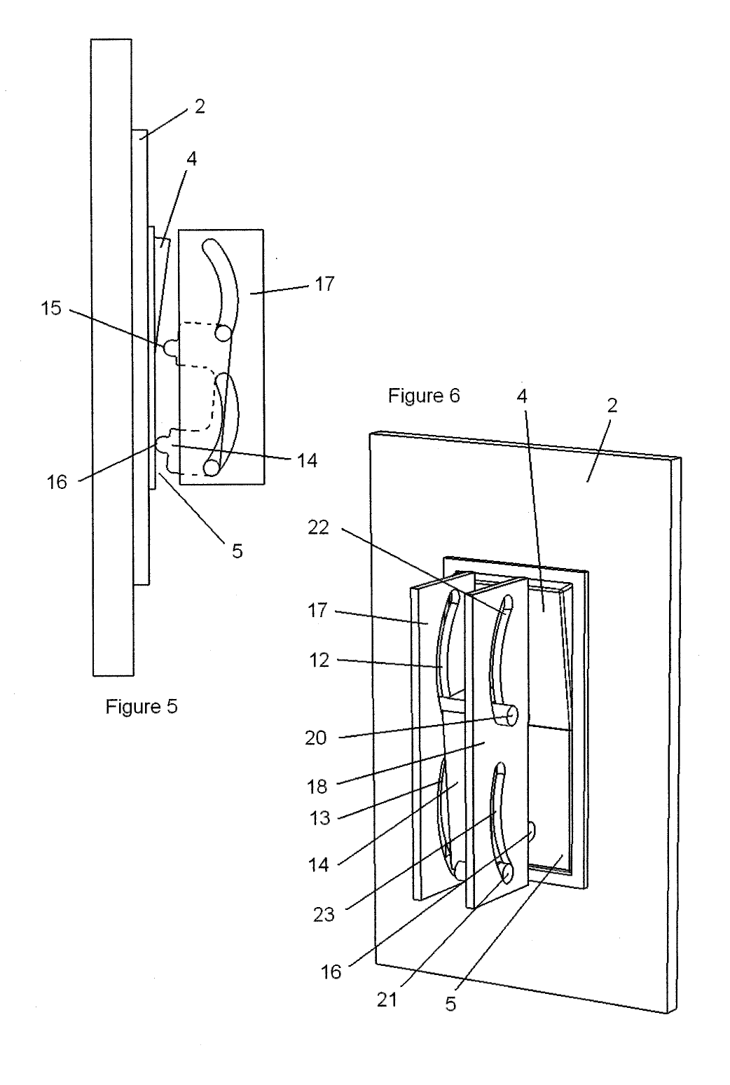

FIG. 5 shows the same components as in FIG. 4 but with the rocker switch now moved to the off position by the actuator.

FIG. 6 shows a perspective view of the components in FIG. 5.

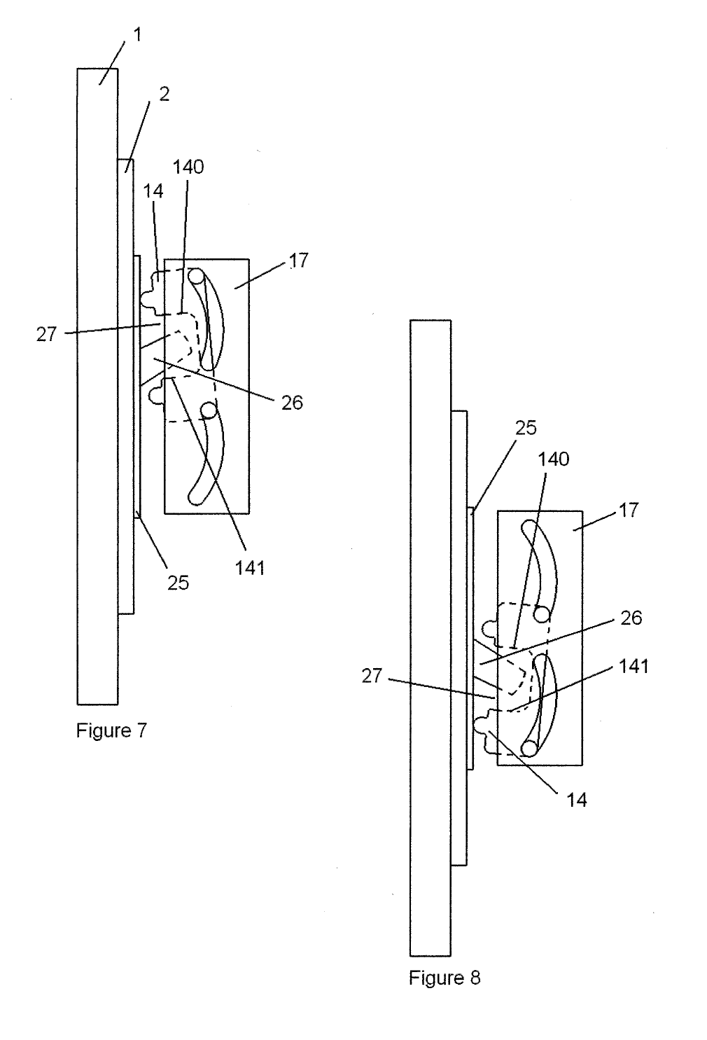

FIG. 7 shows a side view of an actuator and guide plate adjacent to a toggle switch which is in the on position.

FIG. 8 shows a side view of the components in FIG. 7 but with the toggle switch in the off position.

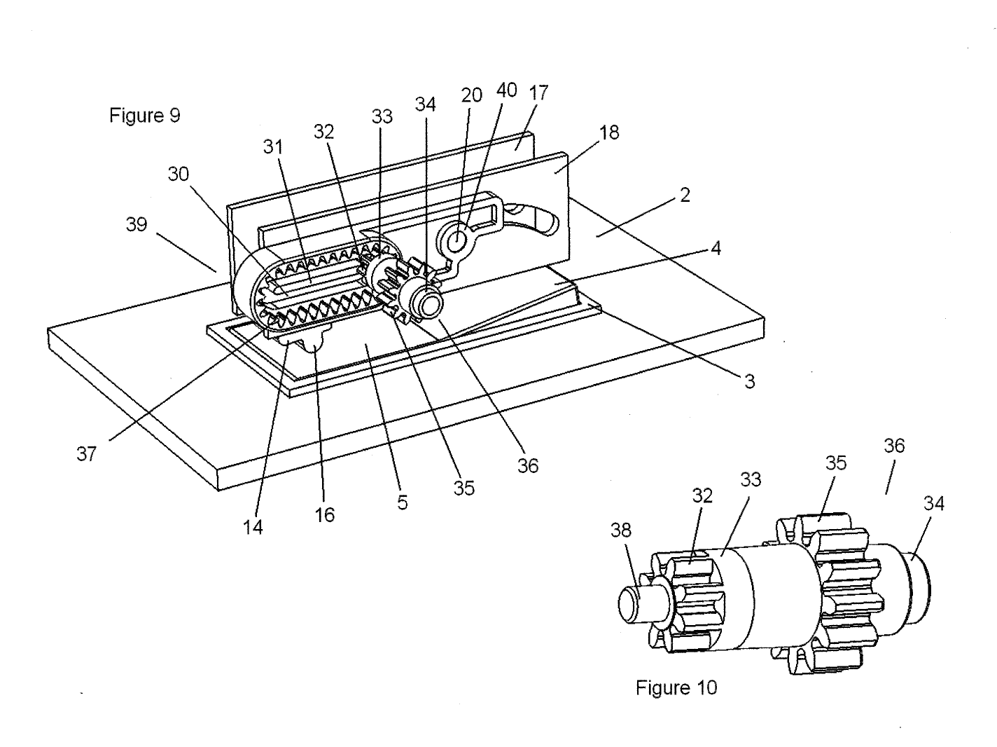

FIG. 9 shows a mangle gear and drive gear arranged to reciprocate the actuator regardless of the direction of input rotation.

FIG. 10 shows the drive gear that drives the mangle gear.

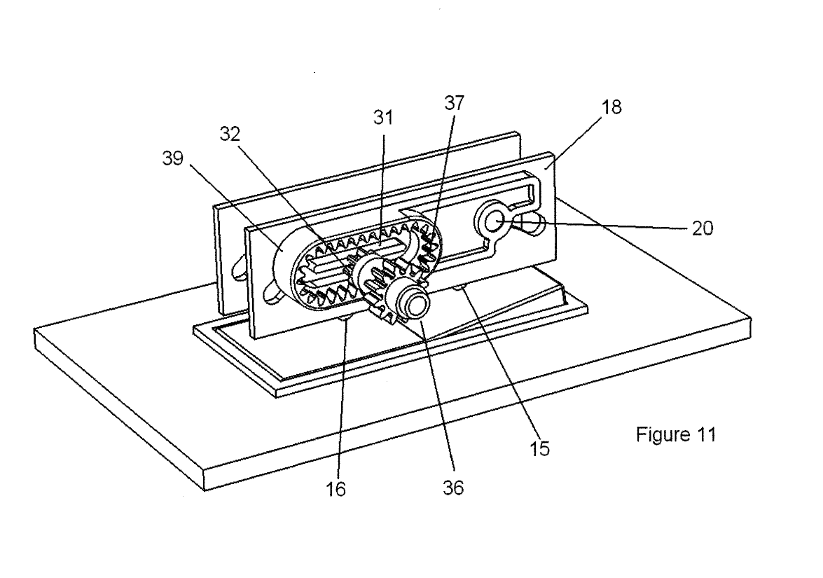

FIG. 11 shows a perspective view of the mangle gear in the first of two possible positions when the actuator is at the midpoint of its reciprocating action.

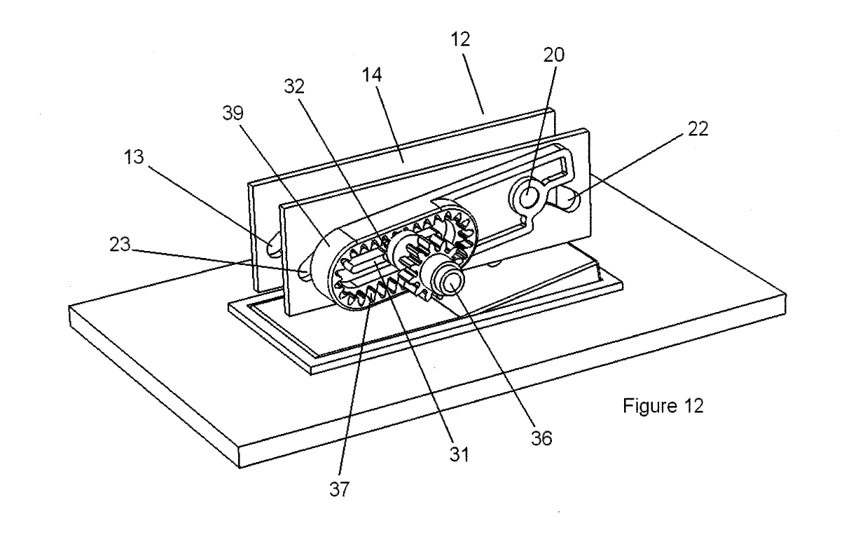

FIG. 12 shows a perspective view of the mangle gear in the second of two possible positions when the actuator is at the midpoint of its reciprocating action.

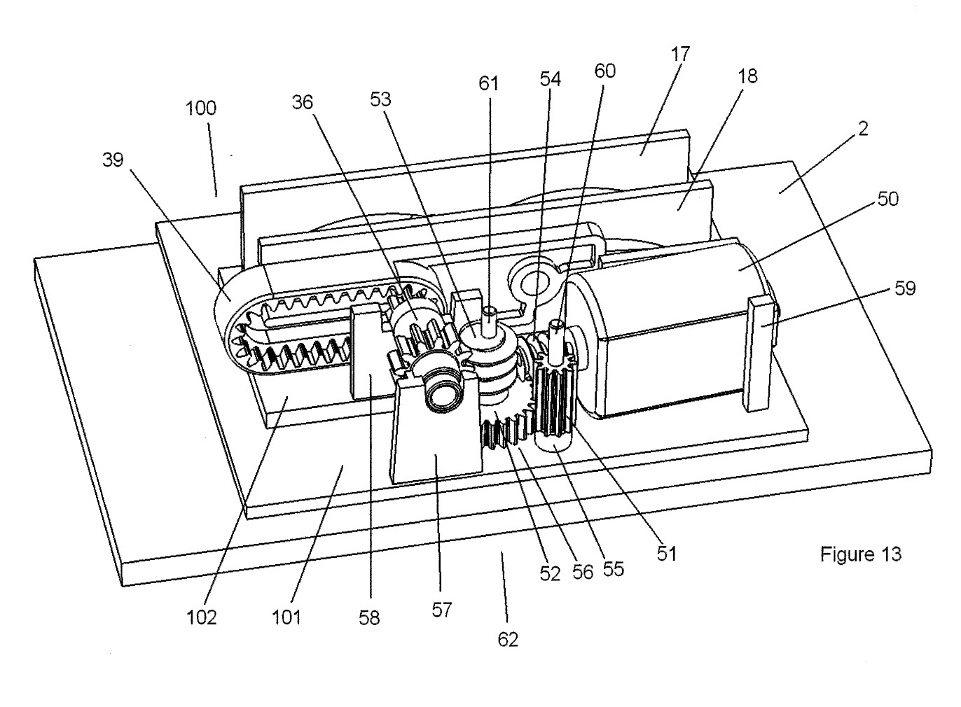

FIG. 13 shows a perspective view of a housing containing a motor and gearbox in addition to previously shown components.

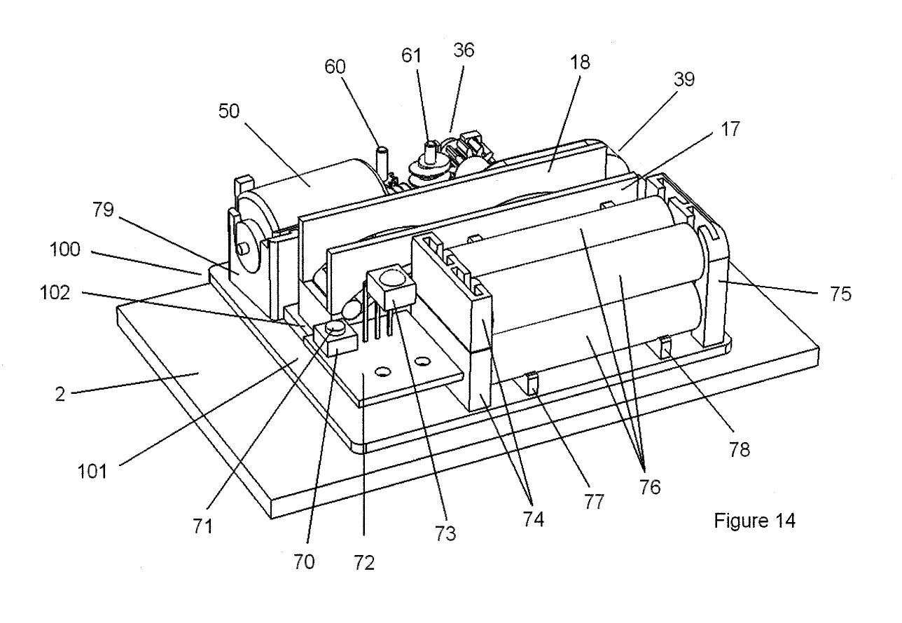

FIG. 14 shows perspective view of a housing further containing a sensor switch attached to a control board and a receiver.

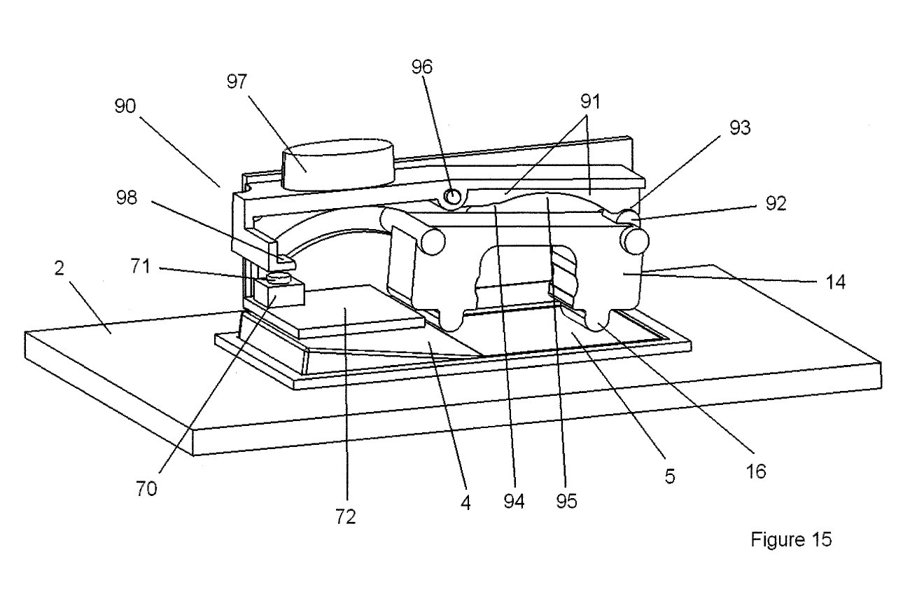

FIG. 15 shows a cut away perspective view of a lever that can be moved by the actuator so that it presses against a position sensor whenever the actuator is not at one or other end of its travel.

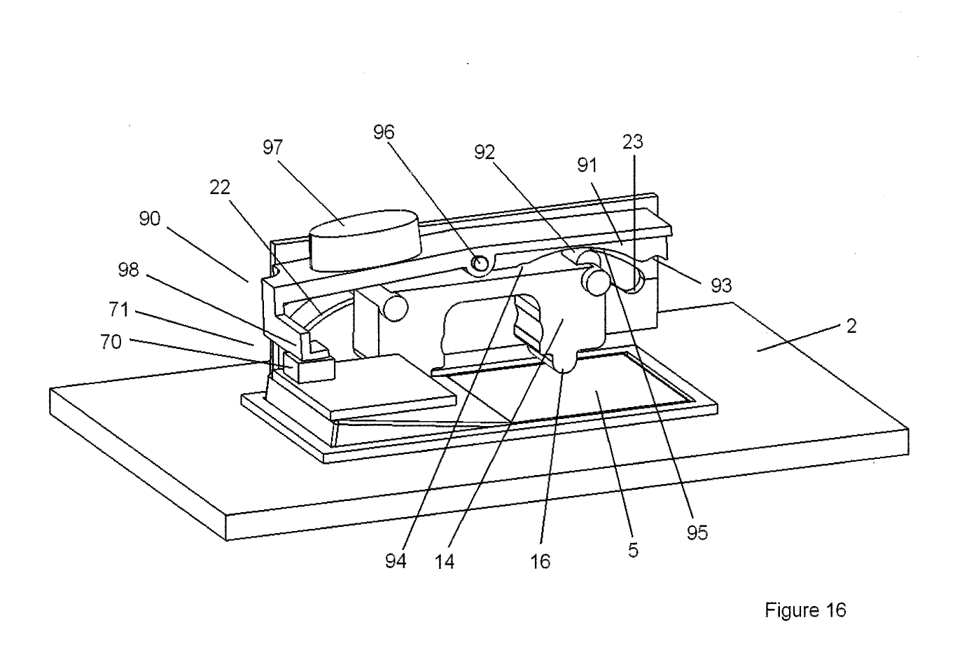

FIG. 16 shows a cut away perspective view of the lever of FIG. 15 when the actuator has travelled midway along the guide plate.

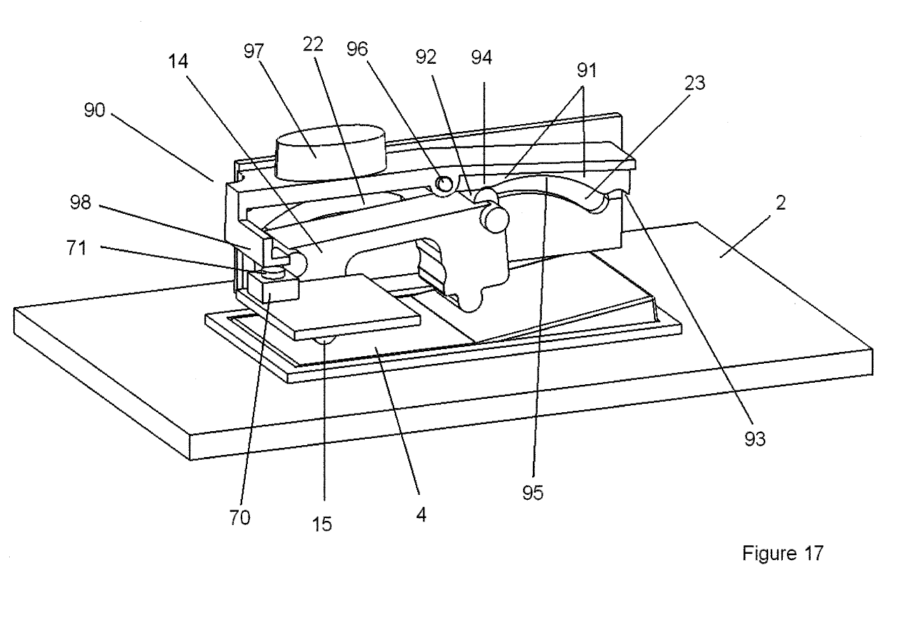

FIG. 17 shows a cut away perspective view of the lever of FIG. 15 when the actuator has travelled to the first end of the linear guide.

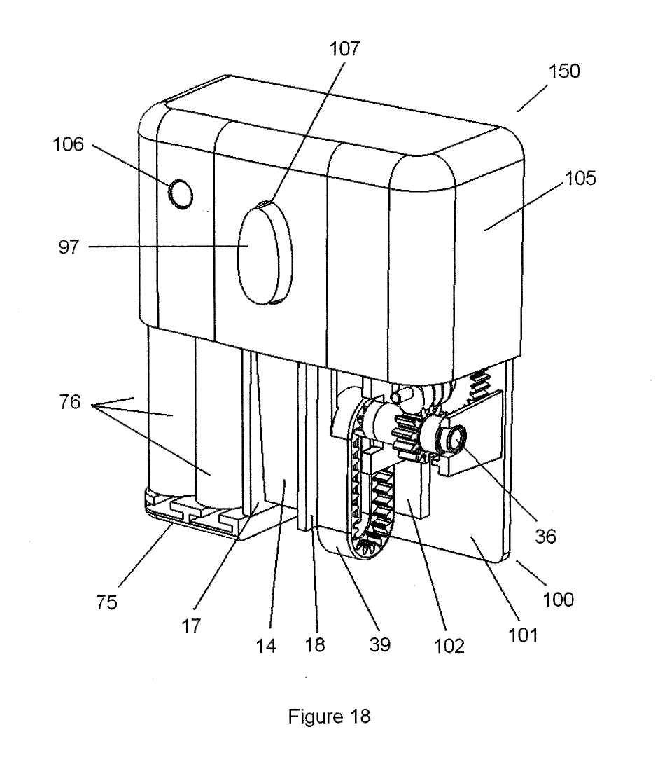

FIG. 18 shows the actuator enclosed within a partially cut away cover.

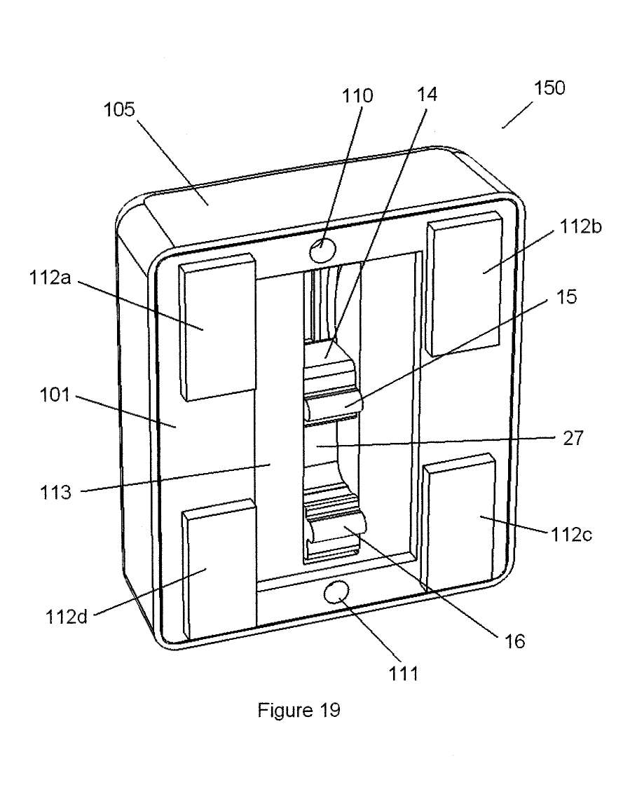

FIG. 19 shows the actuator within a housing and cover with adhesive pads for securing to a switch plate.

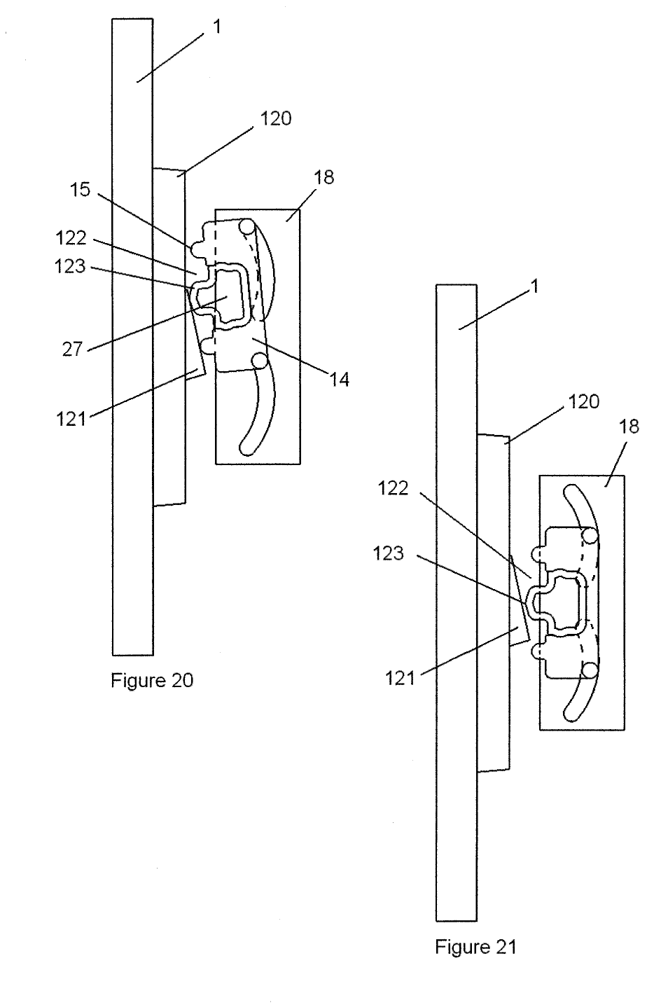

FIG. 20 shows a side view of an actuator and guide plate adjacent to a short length rocker switch which is in the on position.

FIG. 21 shows a side view of the components in FIG. 20 but with the actuator midway along the guide plate.

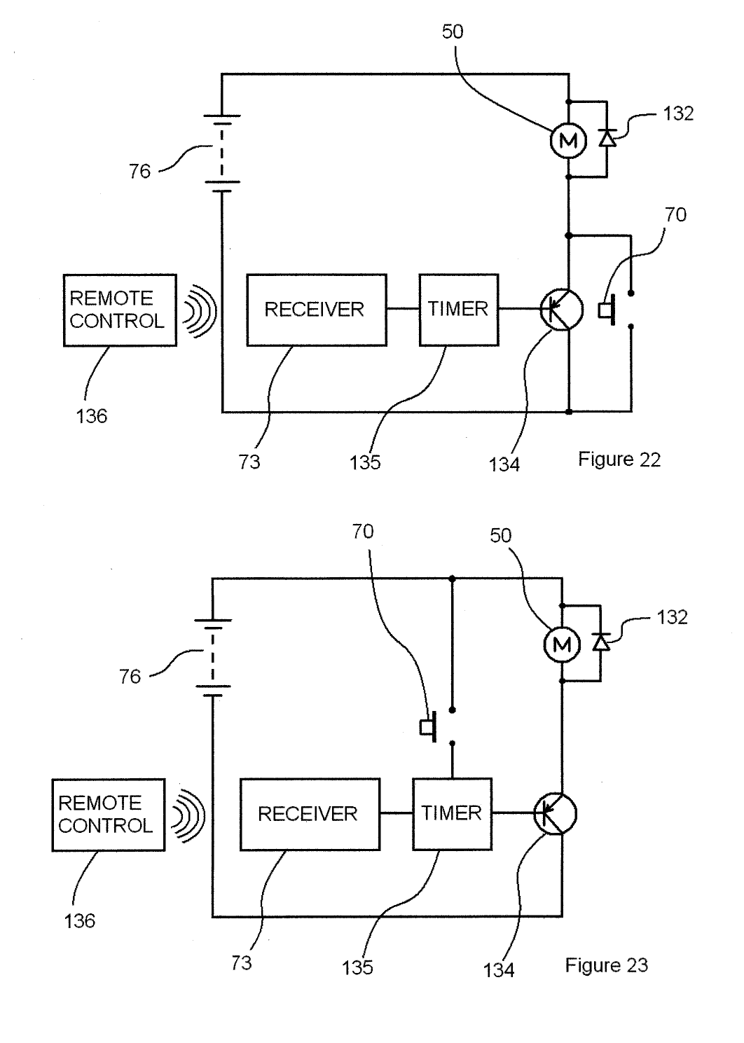

FIG. 22 shows a schematic of a circuit that can be used to control the motor.

FIG. 23 shows a second schematic of a circuit that can be used to control the motor.

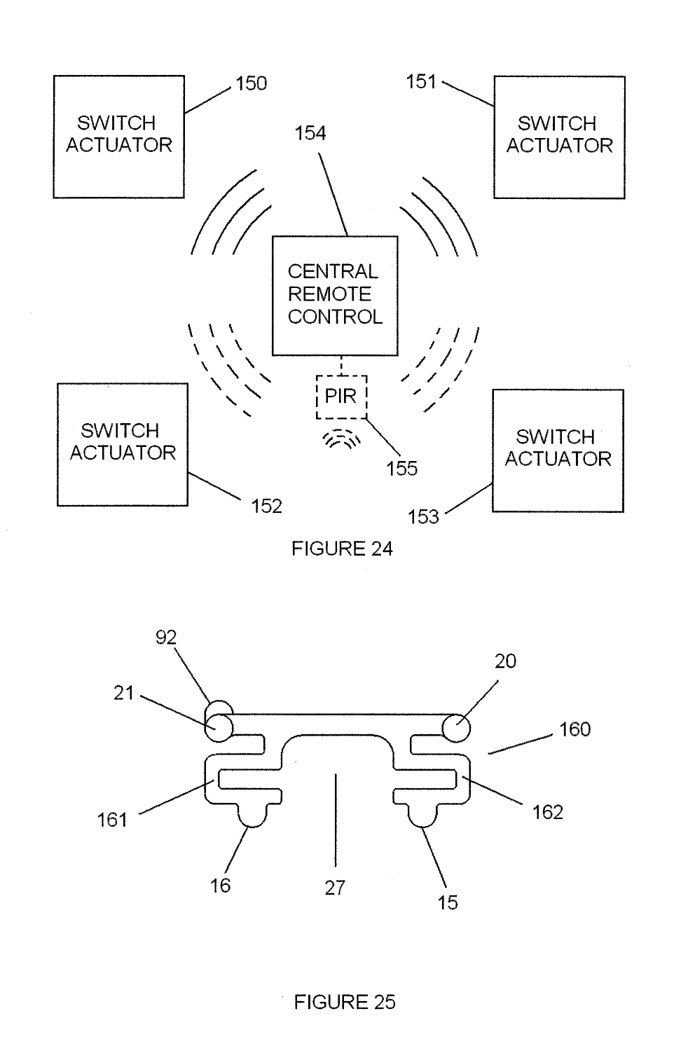

FIG. 24 shows a schematic layout of a central remote control and multiple switch actuators.

FIG. 25 shows an actuator with spring portions.

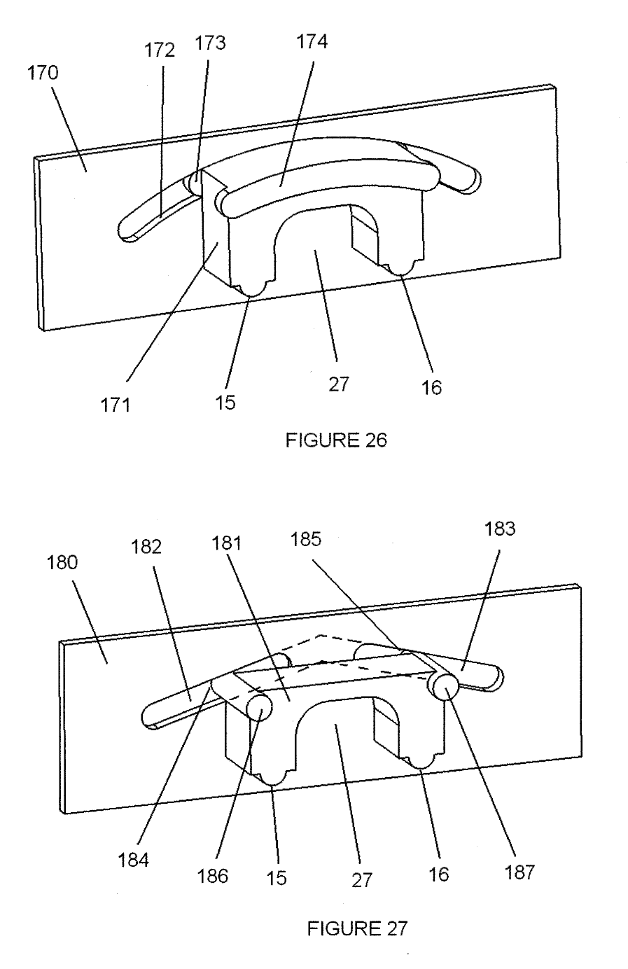

FIG. 26 shows a guide plate with a single arced channel.

FIG. 27 shows a guide plate with two straight but non collinear channels.

The present invention is a switch actuator and remote control that can be attached to a rocker switch or a toggle switch so that the switch can be operated in the manner of a two way switch.

With reference to the drawings, FIG. 1 shows a panel 1 to which is fixed a rocker switch 3 and a wall plate 2. The rocker switch 3 has an on rocker 4 and an off rocker 5. Pressing the on rocker 4 until it is parallel with the wall plate 2, as shown in FIG. 2, will allow the rocker switch 3 to conduct electricity and connect a lighting or similar circuit. Pressing the off rocker 5 will similarly cause the rocker switch 3 to break the lighting or similar circuit so that no electricity is conducted.

An actuator 14 is shown in FIG. 3 with a first actuator end 6 and a second actuator end 7 adjacent to the rocker switch 3. A housing 100, shown later in FIG. 13, supports a first guide plate 17 with a first guide plate end 8 and a second guide plate end 9. The actuator 14 has a first protrusion 10 that runs within a first channel 12 and a second protrusion 11 that runs within a second channel 13. The channels may be arced as shown, connected into a single channel as shown in FIG. 26, or comprise of two non linear channels as shown in FIG. 27 which may be connected to form a single channel. The actuator 14 also has a first bump 15 and a second bump 16 that can press against the on rocker 4 or the off rocker 5 depending on the position of the actuator 14. Other details of the actuator 14, shown later, have been removed for clarity.

In FIG. 4 the actuator 14 is shown in a mid position in which the first bump 15 has moved away from the on rocker 4. The drive mechanism that moves the actuator will be described later. It will be seen that the second bump 16 is not yet in contact with the off rocker 5.

FIG. 5 shows the actuator 14 driven to a position in which the second bump 16 has pressed the off rocker 5 until it is parallel to the wall plate 2. The first bump 15 is raised up and away from the on rocker 4. It will be noted that the motion of the bumps 15, 16 are in an arc as the actuator 14 travels in the channels 12 and 13 so that the bumps 15, 16 lift away from the rocker switch 3 and then move back towards it. In this manner the action of a finger pushing downwards onto an on rocker 4 or off rocker 5 is mimicked. If the first guide plate 17 instead had collinear channels parallel to the wall plate 2, the bumps 15, 16 would move in a plane parallel to the wall plate 2 and would engage with the on rocker 4 or off rocker 5 almost immediately and near the centre of the rocker switch. A very high force would be required to switch the rocker switch 3 in this situation. By using the curved or non collinear channels shown in FIGS. 3, 26 and 27, the force applied by the actuator 14 is greatly reduced.

FIG. 6 shows a second guide plate 18 on the opposite side of the actuator 14. The actuator 14 is shown with an extended third protrusion 20 running in a third channel 22 and a fourth protrusion 21 running in a fourth channel 23. This second guide plate 18 restrains the actuator 14 so that is only able to reciprocate within the two guide plates 17, 18.

In FIG. 7 a toggle switch 25 is shown attached to the panel 1. The toggle lever 26 is shown in the on position and is shown passing into a recess 27 in the actuator 14. As the actuator 14 reciprocates, first recess face 140 and second recess face 141 will alternately strike the toggle lever 26 so that it is pushed from the off position, as shown in FIG. 8, to the on position and back again.

In FIG. 9, housing 100, shown later in FIG. 13, is still omitted for clarity. A mangle gear 39 is shown connected to the actuator 14 via a crank hole 40 in an extended crank portion 41 of the mangle gear 39. The crank hole 40 is a loose fit over extended third protrusion 20 and actuator 14 is shown with bump 16 pressing off rocker 5 into the off position. The mangle gear includes an elongated ring of internal gear teeth 37 and a recessed channel 30 that forms a central rib 31 in the centre of the recessed channel 30. A drive gear 36, shown in more detail in FIG. 10, includes drive gear teeth 32 that engage with the internal gear teeth 37 and an axial protrusion 38 that slides in the recessed channel 30. When the drive gear 36 is turned, drive gear teeth 32 engage with internal gear teeth 37 and drive the mangle gear 39 in a reciprocating manner. The axial protrusion 38, running within recessed channel 30, maintains engagement of gear teeth 32 and internal gear teeth 37. A second set of drive wheel teeth 35 can be seen which are driven by a second worm gear 53, shown later. Plain bearing surfaces 33 and 34 stabilise the drive gear 36 by running in matching plain bearing supports, shown later.

In FIG. 11, the actuator 14, hidden behind second guide plate 18, is in its mid position, as shown in FIG. 4. The drive gear teeth 32 can be seen in the lower section of internal gear teeth 37, with axial protrusion 38 below central rib 31 and in FIG. 12, the actuator 14 is shown again in its mid position but this time with the drive gear teeth 32 in the upper section of internal gear teeth 37, with axial protrusion 38 above central rib 31. As the drive gear 36 rotates, the drive teeth 32 will cause the mangle gear 39 to reciprocate and drive the actuator 14, via extended third protrusion 20, back and forth in guide channels 12, 13, 22, 23. The direction of rotation of drive gear 36 is not important as the net effect on actuator 14 is the same, regardless of the direction of rotation.

In FIG. 13, a housing 100 is shown comprising of a base plate 101 and a raised portion 102 to which first guide plate 17 and second guide plate 18 are attached. Also mounted on base plate 101 are a motor 50, a first axle bearing 55, a second axle bearing 56 (not visible) a first bearing support 57 and a gear reduction chain 62 comprising of a first worm gear 54 connected to the motor shaft, a first gear 51, a second gear 52 and a second worm gear 53 rotationally locked to second gear 52. A second bearing support 58 is mounted on the raised portion 102. Connected to the motor is a motor terminal plate 59. A first axle 60 passes through first gear 51 and a second axle 61 passes through second gear 52 and second worm gear 53.

In FIG. 14, housing 100 is viewed from a different angle and now includes batteries 76 mounted on first battery support 77 and second battery support 78. At one end of the batteries is a first battery connector holder 74 and at the other end is a second battery connector holder 75. A printed circuit board 72 is shown mounted to the housing 100 and mounted to it are a momentary switch 70 and receiver 73 which may be an infrared infra red, radio, ultrasonic, sound activated or similar receiver. Control and timer electronics, not shown, are also attached to this circuit board. A momentary switch button 71 can be depressed to operate momentary switch 70. A first motor support 79 is shown supporting motor 50.

In FIG. 15, the housing and many other components are removed for clarity. A lever 90 is shown with a cam rib 91 that rests against an actuator cam 92 (not shown in earlier drawings) attached to the actuator 14. The cam rib has three zones, a first zone 93, a second zone 94 and a third zone 95. The lever 90 also has a lever pivot 96 about which the lever 90 pivots, and a button 97 that can be pressed by a finger. A lever extension 98 is positioned above momentary switch button 71. If button 97 is pressed, the lever 90 will pivot about lever pivot 96 and lever extension 98 will press down against momentary switch button 71, thereby switching on momentary switch 70.

In FIG. 16, the actuator 14 in FIG. 15 is shown having moved halfway along third and fourth channels 22, 23 and as a result the actuator 14 and actuator cam 92 have been moved upwards away from wall plate 2. Actuator cam 92 is also resting against third zone 95 which has a lower profile than first zone 93 and second zone 94. As a result, the actuator cam 92 raises the cam rib 91 and pivots lever 90 about lever pivot 96. As a result, lever extension 98 pushes down against momentary switch button 71 thereby switching on momentary switch 70.

In FIG. 17, the actuator 14 in FIG. 15 is shown having moved all the way along third and fourth channels 22, 23 and as a result the actuator cam 92 has moved back down towards wall plate 2. Actuator cam 92 is also resting against second zone 94 which has a raise profile relative to third zone 95. As a result, the actuator cam 92 allows cam rib 91 to fall towards it which causes lever 90 to pivot about lever pivot 96. As a result, lever extension 98 lifts away from momentary switch button 71 allowing momentary switch 70 to switch off. A spring (not shown) can be used to assist the moment of lever extension 98 away from momentary switch button 71, or the spring action of the momentary switch button 71 may be sufficient. If desired, a normally closed momentary switch can be used instead of a normally open momentary switch 70 described above.

In FIG. 18 a cover 105 is shown with the lower half removed for clarity and with a first aperture 106 for the receiver 73 and a second aperture 107 for button 97.

In FIG. 19, the reverse view of FIG. 18 with the full cover 105 is shown. Assembly screw apertures 110 and 111 are provided for assembly screws (not visible) and double sided adhesive pads 112a, 112b, 112c, 112d are shown attached to housing 100 providing a means to attach the housing 100 to the wall plate 2, not visible. Instead of double sided adhesive pads, hook and loop pads or similar reusable pads can be used instead. Also visible is actuator 14, recess 27, first bump 15 and second bump 16. Reverse side of raised portion 102 is also shown providing a recess 113.

In FIG. 20 a small wall plate 120 with a short rocker 121 is shown. As first bump 15 is not in contact with the short rocker 121, an insert 122 can be inserted into recess 27 to provide a central bump 123. This central bump 123 moves with actuator 14 and will press a short rocker 121 in a similar manner to rocker switch 3. In this view second guide plate 18 is visible and first guide plate 17 is not. It will be noted that the motion of the central bump 123 is in an arc as the actuator 14 travels in the channels 22, 23 so that the central bump 123 lifts away from the short rocker 121 and then moves back towards it. In this manner the action of a finger pushing downwards onto the short rocker 121 is mimicked. In FIG. 21, the actuator 14 of FIG. 20 can be seen in its mid travel position with the central bump 123 having been lifted clear of the short rocker 121.

In FIG. 22 a circuit comprises a battery 76 or other power supply connected to a motor 50 with a transistor 134 or similar switching device such as a relay in the circuit. A momentary switch 70 is connected in parallel with the transistor 134 so that if the momentary switch 70 is pressed the motor 50 will run until it is released. A receiver 73 is able to receive a signal from any suitable transmitter such as a remote control 136 and trigger a timer 135 that will switch on the transistor 134 for a predetermined period of time. A protective diode 132 is fitted to the motor 50.

In FIG. 23 a circuit comprises a battery 76 or other power supply connected to a motor 50 with a transistor 134 or similar switching device such as a relay in the circuit. A receiver 73 is able to receive a signal from any suitable transmitter such as a remote control 136 and trigger a timer 135 that will switch on the transistor 134 for a predetermined period of time. A protective diode 132 is fitted to the motor 50. An alternative position of momentary switch 70 now sends a signal to the timer 135.

Referring to FIGS. 3, 8 and 19, with the second actuator end 7 of the actuator 14 at the second linear guide end 9 of first guide plate 17, adhesive pads 112a, 112b, 112c, 112d are used to attach the base plate 101 to a wall plate 2 of a rocker switch 3 or a toggle switch 25. In the case, of a toggle switch 25, the toggle lever 26 will pass into the recess 27. In the case of a rocker switch 3, the second bump 16 will contact and press against the off rocker 5 until it is parallel to the wall plate 2. In the case of a toggle switch 25, the toggle lever 26 will be flicked into the off position as shown in FIG. 8. In the ,case of there being no wall plate 2, the adhesive pads 112a, 112b, 112c, 112d would stick directly to the rocker switch 3 or toggle switch 25 or surrounding surfaces.

FIG. 15 shows the position of the lever 90 at this time with the actuator cam 92 in the first zone 93 of cam rib 91. As a result, momentary switch button 71 is not being pressed. FIG. 9 also clearly shows the position of mangle gear 39 at this time with extended third protrusion 20 of the actuator 14 inside crank hole 40 of extended crank portion 41.

Referring to FIGS. 22 and 23, when the receiver 73 receives a signal from a remote control 136 or other sender unit, the timer 135 will switch on the transistor 134 for a short period of time, for example 0.5 seconds (or a similar switching device such as a relay). This will cause motor 50 to turn and drive the drive gear 36 via the gear reduction chain 62 shown in FIG. 13. As the drive gear 36 rotates it drives mangle gear 39 and actuator 14 starts to move, guided by channels 12, 13, 22 and 23 as shown in FIG. 6. By selecting a suitable motor speed and gearbox ratio, timer 135 will switch off before actuator 14 reaches the end of its travel. However as shown in FIG. 16, whilst the lever cam 92 is in the third zone 95, the lever extension 98 will keep the momentary switch button 71 pressed down. As shown in FIG. 22, this will keep the motor 50 running or, as shown in FIG. 23, will keep a signal going to the timer 135 to extend the period for which the transistor 134 is kept switched on. The motor 50 will therefore continue to drive the mangle gear 39 via gear reduction chain 62 until the lever cam 92 reaches the second zone 94 of cam rib 91 at which point the lever extension 98 will rise and the momentary switch button 71 will be released. As shown in FIG. 22, this will immediately switch off the motor 50 and the actuator 14 will stop moving or, as shown in FIG. 23, the signal from the momentary switch 70 to the timer 135 will stop and the timer will switch off the transistor 134 immediately to stop the motor 50.

When the receiver 73 receives a further signal, the motor 50 is again driven for a short period of time, for example 0.5 seconds. Again the time period is insufficient for the actuator 14 to reach the end of its travel and lever cam 92 again enters the third zone 95 of cam rib 91 causing the lever 90 to pivot about lever pivot 96 and lever extension 98 to press down momentary switch button 71. This again keeps motor 50 running either directly as shown in FIG. 22 or via a signal to timer 135 as shown in FIG. 23, until the lever cam 92 reaches the first zone 93 of cam rib 91 at which time the lever extension 98 can rise off momentary switch button 71 and power to the motor is cut as shown in FIG. 22 or, as shown in FIG. 23, the signal from the momentary switch 70 to the timer 135 will stop and the timer will switch off the transistor 134 immediately to stop the motor.

If, however, lever 90 is manually activated by pressing down on lever button 97 for a brief time of about 0.5 seconds, the motor 50 will immediately drive the actuator 14 so that the lever cam 92 moves into the third zone 95 of cam rib 91 and causes lever extension 98 to hold down momentary switch button 71. As before, the motor 50 will then continue to run until the actuator 14 moves to the end of its travel and the lever cam 92 moves into either the first zone 93 or the second zone 94 at which point the momentary switch button 71 is released by lever extension 98 and power to the motor 50 is switched off as previously described.

As seen in FIGS. 3, 4 and 5, as the actuator 14 is driven from one end of its travel to the other, first bump 15 and second bump 16 will alternately switch on and switch off the rocker switch 3. If, as shown in FIGS. 7 and 8, the switch actuator 150 has been fitted to a toggle switch 25, first recess face 140 and second recess face 141 will alternately flick on and flick off the toggle switch 25.

If the switch actuator 150 is fitted to a small rocker switch 120 with a short rocker 121 as shown in FIGS. 20 and 21, an insert 122 with a central bump 123 can be inserted into recess 27. This allows the central bump 123 to press against the small rocker 121 and alternately switch the small rocker switch 120 on and off.

As seen in FIGS. 3, 4, 5 and 6, as the actuator 14 is driven from one end of its travel to the other, protrusions 10, 11, 20 and 21 are constrained to run within channels 12, 13, 22 and 23. As the channels are pairs of dissimilar arcs, the resulting motion of the actuator 14 is both up and down relative to the wall plate 2 as well as the actuator 14 rocking so that the first bump 15 of the actuator is closer to the rocker switch 3 when it has travelled to the first end 8 of the guide plates 17, 18 whilst the second bump 16 of the actuator 14 is closer to the rocker switch 3 when the actuator 14 has travelled to the second end 9 of the guide plates 17, 18 each bump 15, 16 of the actuator 14 being able to press down in turn against the rocker switch 3 so that as the actuator 14 reciprocates along the guide plates 17, 18 the rocker switch 3 is pressed alternately on and off.

The advantage of the resultant up and down motion of the actuator 14 relative to the wall plate 2 is that it closely mimics the pressing action of a finger against a rocker switch 3 and allows a lower activation force to be used against the end of the on rocker 4 and off rocker 5 rather than having to press with a high force near the centre of the on rocker 4 and off rocker 5.

The advantage of the resultant rocking motion of the actuator 14 is that it creates clearance underneath the bump 15 or 16 of the actuator 14 that is not pressing against the on rocker 4 or off rocker 5, thereby allowing the opposite end of the rocker to rise up without striking the opposite bump 15 or 16 of the actuator 14.

It should be noted that actuator protrusions and channels can be reversed so that non collinear channels are placed on the actuator and the protrusions placed on the guide plates.

Additionally, actuator protrusions do not have to be placed at either end of the actuator but can instead be placed at one end and centrally, both inboard or other arrangements to get the desired effect of causing the actuator to rise and fall and rock.

In a second embodiment, the switch actuator 150 can include a timer 135 with a secondary function as a programmable timer so that the transistor 134 is switched on and off periodically to switch lights or other devices on and off and give the illusion of an empty home being inhabited. Use of a remote control 136 or similar sender unit can be programmed to override the timer 135, as can manually pressing the momentary switch 70.

In a third embodiment, the switch actuator 150 can include a timer 135 that operates solely as a programmable timer with no receiver 73 so that the transistor 134 is switched on periodically to switch lights or other devices on and off and give the illusion of an empty home being inhabited. Pressing momentary switch 70 would override the programme.

In a fourth embodiment, as shown in FIG. 24, a central remote control 154 is programmable to send a signal to activate any one of one or more switch actuators 150, 151, 152 and 153. This allows one or more light switches to be activated to give the illusion of an empty home being inhabited. The central remote control could also feature a passive infra red receiver, PIR 155, so that if PIR 155 was triggered a signal would be sent to one or more switch actuators.

In a fifth embodiment, in order to compensate for a rocker switch 3 that has an on rocker 4 or an off rocker 5 that is higher from the wall plate 2 than expected, an alternative design for a springy actuator 160 is shown in FIG. 25. Instead of being a solid block with a recess 27 in the middle, the springy actuator 160 is cored out so that there are two springy zones 161 and 162 and the springy actuator 160 is preferably made from a polymer material such as PA66 or POM.

In a sixth embodiment, FIG. 26 shows a guide 170 featuring a single channel 172 and an actuator 171 that has a single curved protrusion 173 and 174 on each side. As the curved protrusion 173 reciprocates within single channel 172, bumps 15 and 16 will alternately rise and fall. A second guide could be added for the second single curved protrusion 174, or just the single guide 170 could be used to guide the actuator 171. A recess 27 is shown for accommodating a toggle lever 26, not shown.

In a seventh embodiment, FIG. 27 shows a guide plate 180 featuring two straight, non collinear channels 182 and 183. First and second protrusions 184 and 185 slide within these non collinear channels causing the actuator 181 to rise and fall and also tilt as it reciprocates. A second guide could be added for the third and fourth protrusions 186 and 187, or just the single guide plate 180 could be used to guide the actuator 181. A recess 27 is shown for accommodating a toggle lever 26, not shown. The two non collinear channels 182 and 183 could be extended so that they form a single channel as indicated by the dotted lines.

An eighth embodiment Includes an actuator 14 or 171 with or without a central recess 27 that can operate a push button or momentary action switch.

While the preferred embodiments of the invention have been shown and described, it will be understood by those skilled in the art that changes or modifications may be made thereto without departing from the true spirit and scope of the invention.

What is claimed:

1. A removable electrical switch control device for interchangeable use between both rocker and toggle type switches, the electrical switch control device having a reciprocating actuator with a first and second end which travels in a curved path so that a rocker switch is pressed at the ends of the rocker rather than near the centre where a higher force is required, the device comprising;
a housing adapted to be removably mountable to at least one of an existing rocker switch plate and an existing toggle switch plate without modification to the existing rocker switch plate and the existing toggle switch plate;
an actuator that reciprocates back and forth within the housing whilst following a curved path so that the two ends of the actuator move up and down relative to the switch plate as they reciprocate enabling the actuator to alternately press each end of the rocker switch near the end of the rocker and with the first and second ends of the actuator being alternately closer and further away from the switch plate as the actuator reciprocates;
a cam follower mounted on the actuator;
a recess in the center of the actuator to receive a toggle lever of a conventional toggle switch and to flip it from one position to another as the actuator reciprocates;
a motor mechanically connected to the actuator;
a battery pack electrically connected to the motor and to supply power to the motor; and
a control element electrically connected between the motor and the battery pack.

2. The electrical switch control device of claim 1 wherein the actuator includes at least one guide plate with at least one guide channel to guide the actuator in a curved manner as it reciprocates.

3. The electrical switch control device of claim 1 in which at least two guide channels are provided in each guide plate to guide the actuator.

4. The electrical switch control device of claim 1 in which at least two guide channels are provided in each guide plate to guide the actuator, the guide channels being arranged so that the actuator tilts relative to the switch plate as it reciprocates.

5. The electrical switch control device of claim 1 in which the motor is mechanically connected to the actuator via a gearbox that incorporates a mangle gear to convert rotary motion into reciprocating motion.

6. The electrical switch control device of claim 1 in which the control element incorporates a timer, a timer controlled switch connected to the control element and a momentary switch connected to the control element

7. The electrical switch control device of claim 6 in which a lever is housed within the housing, the lever includes:
a button that allows the lever to be pressed;
a pivot point about which the lever pivots within the housing;
a cam surface; and
a lever face positioned above the momentary switch.

8. The electrical switch control device of claim 7 in which the cam follower is adjacent to the cam surface of the lever so that as the actuator reciprocates, the cam follower moves along the cam surface.

9. The lever of claim 7 in which the cam surface of the lever has two end zones and a middle zone, the middle zone being positioned so that when the cam follower presses against the middle zone, the lever pivots and the lever face presses the momentary switch.

10. The lever of claim 9 in which the cam surface outer two end zones are positioned so that when the cam follower is adjacent to them, the lever is free to pivot away from the momentary switch.

11. The electrical switch control device of claim 1 in which the control element incorporates a timer, a timer controlled switch connected to the control element and a momentary switch connected to the control element.

12. The electrical switch control device of claim 1 in which a receiver is connected to the control element to allow remote operation of the control element to enable remote actuation of the removable electrical switch control device.

13. The electrical switch control device of claim 1 in which a programmable timer is connected to the control element and configured to allow pre-programmed operation of the control element to enable pre-programmed actuation of the removable electrical switch control device.

14. The electrical switch control device of claim 7 configured so that a pressing of the button causes the lever to pivot and the lever face to press the momentary switch to signals to the control element to electrically close the timer controlled switching device for a period of time controlled by the timer so that the motor moves the actuator a short distance away from one of its end of travel positions. This causes the cam follower to move from one of its end zones to the middle zone of the lever and keeps the momentary switch depressed by the lever face until the actuator has moved to its opposite end of travel position and the cam follower is in the opposite end zone on the cam surface allowing the lever to pivot back to its starting position due to the momentary switch returning to its open position and thus enable a short press of the button to cause the actuator to move from one end of travel position to the other to switch at lease one of a rocker and toggle switch.

15. The electrical switch control device of claim 12 configured such that reception by the receiver of a suitable signal from a remote control device signals to the control element to electrically close the timer controlled switching device for a period of time controlled by the timer so that the motor moves the actuator a short distance away from one of its end of travel positions to cause the cam follower to move from one of its end zones to the middle zone of the lever and keeps the momentary switch depressed by the lever face until the actuator has moved to its opposite end of travel position and the cam follower is in the opposite end zone on the cam surface allowing the lever to pivot back to its starting position due to the momentary switch returning to its open position to thus switch one of a rocker and toggle switch.

16. The electrical switch control device of claim 13 configured so that a signal from a programmable timer signals to the control element to electrically close the timer controlled switching device for a period of time controlled by the timer so that the motor moves the actuator a short distance away from one of its end of travel positions to cause the cam follower to move from one of its end zones to the middle zone of the lever and keeps the momentary switch depressed by the lever face until the actuator has moved to its opposite end of travel position and the cam follower is in the opposite end zone on the cam surface allowing the lever to pivot back to its starting position due to the momentary switch returning to its open position as the actuator moves from one end of travel position to the other to effect the switching of at least one of a rocker and toggle switch.

17. The electrical switch control device of claim 1 and further comprising a central remote control connected to the electrical switch control device to enable control of the electrical switch control device according to at least one of a timed program within the central remote control and a sensor in s communication with the central remote control.

18. The electrical switch control device of claim 1 configured with a recess for insertion of a insert so that the insert can enable effective pressing of a rocker of a short form rocker switch.
